(19) United States
(12) Patent Application Publication
(10) Pub. No.: US 2016/0221298 A1
(43) Pub. Date: Aug. 4, 2016

(54) REINFORCED THERMOPLASTIC ARTICLES, COMPOSITIONS FOR THE MANUFACTURE OF THE ARTICLES, METHODS OF MANUFACTURE, AND ARTICLES FORMED THEREFROM

(71) Applicant: SABIC Global Technologies B.V., BERGEN OP ZOOM (NL)

(72) Inventors: Erich Otto Teutsch, Pittsfield, MA (US); Craig Lawrence Milne, Pittsfield, MA (US); Peter James Zuber, Pittsfield, MA (US)

(21) Appl. No.: 14/614,043

(22) Filed: Feb. 4, 2015

(51) Int. Cl. B32B 5/08; B32B 5/10; B32B 5/12; B29C 51/08; B29C 35/02; B29C 35/16; B29C 43/20; C08J 5/04; B32B 5/26

(52) U.S. Cl. CPC B32B 5/08; C08J 5/043; B32B 5/10; B32B 5/12; B32B 5/26; B29C 35/02; B29C 35/16; B29C 43/203; B29C 51/082; B32B 2250/02; B32B 2250/20; B32B 2262/02; B32B 2262/101; B32B 2305/026; B32B 2305/08; B32B 2605/18; B32B 2605/10; B32B 2605/003; B32B 2605/12; B29L 2009/00

(57) ABSTRACT

A composition for the manufacture of a porous, compressible article, the composition comprising a combination of: a plurality of reinforcing fibers; a plurality of thermoplastic fibers; optionally a plurality of polymeric binder fibers; and continuous spaced carrier fibers; wherein the polymeric binder fibers have a melting point lower than the thermoplastic fibers; methods for forming the porous, compressible article; and articles containing the porous, compressible article. An article comprising a thermoformed composite is also disclosed, wherein the composite is not supported by a scrim layer and the composite exhibits improved conformation to fine mold details to which the scrim layer could not accurately conform.

### BACKGROUND

This disclosure relates to reinforced thermoplastic articles, in particular fiber-reinforced polyimide articles that can be thermoformed, compositions for the manufacture of the thermoformable articles, and methods of manufacture, articles, and uses thereof.

Thermoplastic articles containing reinforcing fibers are being used to an increasing extent for the production of components employed in the interior of vehicles such as commercial aircraft, ships, and trains. In addition, materials useful in manufacture of thermoplastic articles containing reinforcing fibers generally also have good processability for forming the articles, and desirable physical properties such as attractive surface finishes, toughness to minimize the propensity of the parts to crack during use or secondary operations, weatherability, and transparency where desired. However, it is desirable to improve the formability of the articles, particularly in conformance of the thermoformed article to finer details on the mold and faithful reproduction of the mold shape on the upper surface of the reinforced thermoplastic thermoformed articles.

There accordingly remains a continuing need in the art for materials useful in the manufacture of reinforced thermoplastic thermoformed articles that conform more consistently and faithfully to the mold shape on which they are formed. Yet a further advantage would be for thermoformed articles to have one or more of toughness, weatherability, chemical resistance, and ease of cleaning.

### SUMMARY

The invention relates to a composition for the manufacture of a porous, compressible article, the composition comprising a combination of: a plurality of reinforcing fibers; a plurality of thermoplastic fibers; and said combination of fibers is arranged in one or more layers; and further comprising: a plurality of spaced continuous carrier fibers, which are present on, and substantially transit, a surface of at least one such layer; and said composition does not contain a scrim carrier layer.

In another embodiment, the invention relates to a method for forming a porous article, the method comprising: forming a layer comprising a suspension of the composition in liquid; at least partially removing the liquid from the suspension to form a web; heating the web under conditions sufficient to remove any remaining liquid from the web and to melt the thermoplastic fibers; and cooling the heated web to form the porous mat, wherein the porous article comprises a network of the reinforcing fibers and the thermoplastic fibers and a plurality of spaced carrier fibers on a surface of the porous mat.

In another embodiment, the invention relates to a porous article comprising: a network of a plurality of reinforcing fibers and a plurality of thermoplastic fibers deposited on the network comprising melted and cooled thermoplastic fibers, and a plurality of spaced continuous carrier fibers which transit said porous article, either on a surface of a layer of said network, or at the interface between two layers of said network.

In another embodiment, the invention relates to a method of forming a composite, the method comprising: heating and compressing at least one of the porous articles under conditions sufficient to melt the thermoplastic fibers and consolidate the network, cooling the heated, compressed article under pressure to form the composite comprising: a network comprising a plurality of reinforcing fibers; and a matrix comprising melted and cooled thermoplastic fibers, and a plurality of spaced continuous carrier, which transit said porous article, either on a surface of a layer of said network or at the interface between two layers of said network.

In another embodiment, the invention relates to a thermoformable composite, comprising: a network comprising a plurality of reinforcing fibers and a matrix comprising melted and cooled thermoplastic fibers, and a plurality of spaced continuous carrier fibers which transit said network, either on a surface of a layer of said network or at the interface between two layers of said network, and wherein the composite has a minimum degree of loft of greater than or equal to three.

In another embodiment, the invention relates to a method of forming an article, the method comprising: thermoforming the composite to form the article.

In another embodiment, the invention relates to an article, comprising a thermoformed composite. The formed composite article need not be porous, since that depends on what other layers may be added such as the decorative surface films for aircraft interior panels, which has the dual purpose of being difficult to mark and has an easy to clean surface.

In another embodiment, the invention relates to a composite, comprising: a network comprising a plurality of thermoplastic fibers and reinforcing fibers selected from metal fibers, metallized inorganic fibers, glass fiber, carbon fibers, ceramic fibers, mineral fibers, basalt fibers and polymer fibers having a Tg at least 50° C. higher than the processing temperature for the thermoplastic matrix resin, and combinations thereof; and a matrix comprising melted and cooled thermoplastic fibers, wherein the composite has a minimum degree of loft of greater than or equal to three, and the loft of the composite is within 30% over the entirety of the composite.

### BRIEF DESCRIPTION OF THE DRAWINGS

FIG. 1 is a plan view of the surface of a porous mat showing the continuous spaced carrier fibers applied as unidirectional fibers in the machine direction.

FIG. 2 is a plan view of the surface of a porous mat showing the continuous carrier fiber applied in a diagonal traversing pattern at an angle relative to the machine direction.

### DETAILED DESCRIPTION

The invention relates to a method of manufacturing plastic composite sheets containing continuous carrier fibers which can be used in semi-structural applications. For multi-layered sheets, the continuous carrier fibers can be incorporated between the layers and for single layered sheets, the fibers are exposed on a bottom surface of the composite sheet. The continuous carrier fibers can be introduced during the consolidation process. A continuous double belt press can be used for this purpose.

The inventors hereof have developed a reinforced thermoplastic thermoformable article, referred to herein as a “composite,” which can be thermoformed into an article having a low heat release rate and low smoke density. In an embodiment, the combustion products of the thermoformable article have low toxicity. To manufacture the composite, a porous mat is formed from a composition containing a combination of reinforcing fibers, and thermoplastic fibers. Sufficient heat is provided, for example within the drying step, to melt some of the thermoplastic fibers thus providing the mat with sufficient integrity to maintain its network structure during processing, which can include winding, shipping, unwinding and feeding into a continuous press.

In some embodiments, wherein the processing temperature in the drying step is not sufficient to begin sufficient melting of the thermoplastic fiber to produce interfiber connections, a binder is added to prevent the mat from falling apart during handling. The porous mat is then consolidated by heating, under compression, to a temperature sufficient to melt the thermoplastic fibers, and any optional binder fibers, to form a composite, followed by compression while cooling to below the Tg of the thermoplastic. Use of the combination of the fibrous components allows uniform mixing and distribution of the components in the porous mat, and can provide mats having thinner profiles. The selected polymers are also sufficiently stable to survive repeated heating to processing or forming temperature with minimal degradation.

In an embodiment, the porous compressible article is of the type described in U.S. Pat. No. 7,244,501, the disclosure of which is hereby incorporated herein by reference. Porous compressible articles of this type would be improved by eliminating the scrim layer and instead supporting the network of fibers which comprises the porous body on a plurality of spaced continuous carrier fibers which transit said network, either on the bottom surface of a layer of said network or at the interface between two layers of said network for best effect.

Long reinforcing fibers—In an embodiment, a quantity of long reinforcing fibers are provided to provide internal structure to the mat. In an embodiment, the long reinforcing fibers are from 12 mm to 75 mm in length. In an embodiment, these long reinforcing fibers are present at from 0 wt. % to 20 wt. %, replacing an equal amount of short reinforcing fibers. The long reinforcing fibers are selected from carbon fibers, aramid fibers and other materials selected to provide internal structure to the mat. In an embodiment, a composite containing the above-described long reinforcing fibers is transferred for thermoforming without a carrier scrim or spaced continuous carrier fibers.

The properties and composition of the porous mat can be varied according to need, for example, by varying the type, dimensions, and amount of reinforcing fiber. The thermoplastic and/or reinforcing fiber color can also be varied to produce a decorative effect if a clear surface film, reverse printed or not is applied (only after forming), such as a polyvinylidene fluoride (PVDF) outer, protective surface film. If the decorative film can survive the forming temperature, such as ULTEM film, the outer protective surface film can be added before forming, such as during consolidation, or a surface film (if not having specific requirements) may be formed in situ by adjusting the concentration of resin to reinforcing fibers in the outermost layer. In an embodiment, the final thermoformed product has excellent flame, smoke and toxicity (FST) properties without requiring any additional layers or additives.

The composites formed from the porous mats have a degree of loft of 3 or more, with excellent uniformity across the thickness of the mat. The composites can be thermoformed, for example, to provide an article. The composite can thus be used in the manufacture of components that meet the FAR requirements for low heat, low smoke density, and/or low levels of toxic combustion by-products. In an embodiment, the composite satisfies the following criteria: (1) a peak heat release of less than 65 kW/m², as measured by FAR 25.853 (OSU test); (2) a total heat release at 2 minutes of less than or equal to 65 kW-min./m.² as measured by FAR 25.853 (OSU test); and an NBS optical smoke density of less than 200 when measured at 4 minutes, based on ASTM E-662 (FAR/JAR 25.853).

The singular forms “a,” “an,” and “the” include plural referents unless the context clearly dictates otherwise. The endpoints of all ranges reciting the same characteristic or component are independently combinable and inclusive of the recited endpoint. The term “combination” is inclusive of blends, mixtures, alloys, reaction products, and the like. The term “and a combination thereof” is inclusive of the named component and/or other components not specifically named that have essentially the same function.

Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values. The endpoints of all ranges reciting the same characteristic or component are independently combinable and inclusive of the recited endpoint. Unless expressly indicated otherwise, the various numerical ranges specified in this application are approximations. The term “from more than 0 to” an amount means that the named component is present in some amount more than 0, and up to and including the higher named amount.

“Melt temperature” as used herein refers to the melt temperature of crystalline polymers, or the glass transition or softening temperature of amorphous polymers. “Processing temperature” refers to the temperature required to perform the desire process and for amorphous resins such as ULTEM resin may be more than 200 above the glass transition temperature.

Compounds are described herein using standard nomenclature. A dash (“-”) that is not between two letters or symbols is used to indicate a point of attachment for a substituent. For example, —CHO is attached through the carbon of the carbonyl (C═O) group. The term “alkyl” includes branched or straight chain, unsaturated aliphatic C₁₋₃₀ hydrocarbon groups e.g., methyl, ethyl, n-propyl, i-propyl, n-butyl, s-butyl, t-butyl, n-pentyl, s-pentyl, n- and s-hexyl, n- and s-heptyl, and, n- and s-octyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example, methoxy, ethoxy, and sec-butyloxy groups.

“Alkylene” means a straight or branched chain, saturated, divalent aliphatic hydrocarbon group (e.g., methylene (—CH₂—) or, propylene (—(CH₂)₃—)).

“Cycloalkylene” means a divalent cyclic alkylene group, —CₙH₂ₙ₋ₓ, wherein x represents the number of hydrogens replaced by cyclization(s). “Cycloalkenyl” means a monovalent group having one or more rings and one or more carbon-carbon double bond in the ring, wherein all ring members are carbon (e.g., cyclopentyl and cyclohexyl).

The term “aryl” means an aromatic hydrocarbon group containing the specified number of carbon atoms, such as to phenyl, tropone, indanyl, or naphthyl.

The prefix “halo” means a group or compound including one more of a fluoro, chloro, bromo, iodo, and astatino substituent. A combination of different halo groups (e.g., bromo and fluoro) can be present. In an embodiment, only chloro groups are present.

The prefix “hetero” means that the compound or group includes at least one ring member that is a heteroatom (e.g., 1, 2, or 3 heteroatom(s)), wherein the heteroatom(s) is each independently N, O, S, or P.

“Substituted” means that the compound or group is substituted with at least one (e.g., 1, 2, 3, or 4) substituents independently selected from, a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl) a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded.

As described above, a composition having different types of fibers is used to form a porous mat, which in turn is consolidated to provide the composite. The compositions for forming the porous mat include a plurality of reinforcing fibers and a plurality of thermoplastic fibers.

The reinforcing fibers can be metal fibers (e.g., stainless steel fibers), metallized inorganic fibers, glass fibers (e.g., lime-aluminum borosilicate glass that is soda-free (“E” glass), A, C, ECR, R, S, D, or NE glasses), graphite fibers, carbon fibers, ceramic fibers, mineral fibers, basalt fibers, polymer fibers having a melt temperature at least 150° C. higher than the polyimide, or a combination thereof. The reinforcing fibers generally have a modulus higher than 10 GigaPascals (GPa). In an embodiment, the reinforcing fibers are glass fibers, a compatible non-glass material, or a combination thereof. As used herein, the term “compatible non-glass material” refers to a non-glass material having at least surface adhesion and wetting properties similar to those of glass, which will allow for uniform dispersion with the glass fibers.

The reinforcing fibers can be provided in the form of monofilament or multifilament fibers; non-woven fibrous reinforcements such as chopped strand mat, tissues, papers, and felts or the like. In an embodiment, the reinforcing fibers are discontinuous, in the form of single discrete fibers. Where glass fibers are used and are received in the form of chopped strand bundles, the bundles can be broken down into single fibers before making into paper. The discontinuous reinforcing fibers can be 5 to 75 millimeters (mm) in the longest dimension, 6 to 60 mm, 7 to 50 mm, or 10 to 40 mm in the longest dimension. In addition, the diameter of the discontinuous reinforcing fibers can be 3 to 125 micrometers (μm), and in other embodiments 10 to 100 micrometers.

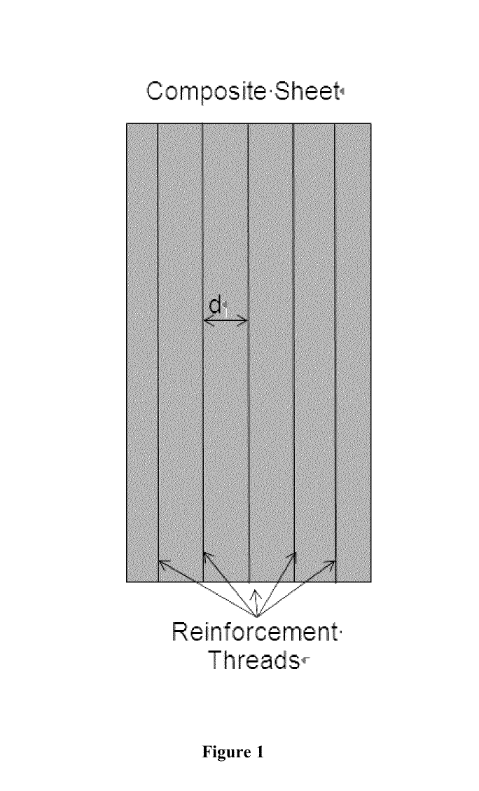

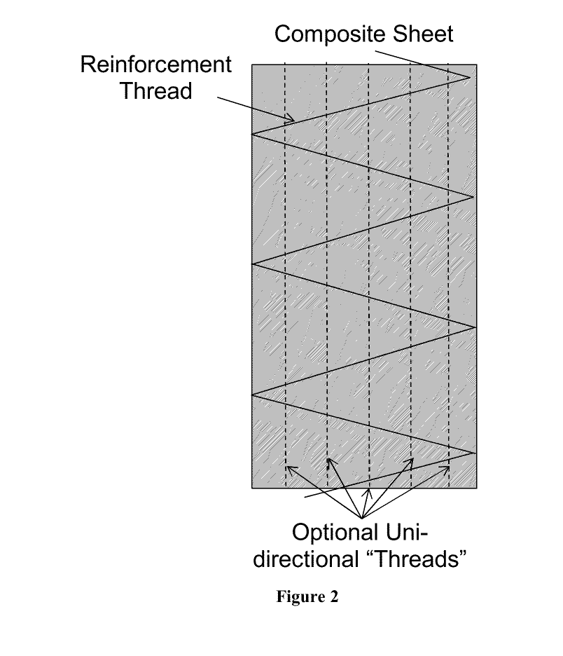

The continuous carrier fibers can be composed of the same range of materials as are the reinforcing fibers, however unlike the reinforcing fibers which are discontinuous, the continuous carrier fibers are selected such that the length, type and thickness of the carrier fibers transit the fibrous mat and provide support for the fibrous mat. The continuous carrier fibers can be spaced as needed, for example, in an embodiment from 1″ to 12″, 2″ to 11″, 3″ to 10″, 4″ to 9″, 5″ to 8″, 6″ to 7″ apart, and can be oriented in various configurations, for example unidirectionally oriented in the machine direction as in FIG. 1, or in the cross-machine direction, or oriented as a traversing fiber which crisscrosses the surface as shown in FIG. 2, either as one single strand, or two single strands, one from each side.

The thermoplastic fibers are selected to provide desired performance properties for the composite after melting to form a polymer matrix. In an embodiment, the thermoplastic fibers are selected to also provide interfiber bonds due to partial melting during the drying process. In another embodiment, the thermoplastic fibers do not melt sufficiently under drying conditions to provide sufficient structural integrity to the porous composite structure and a binder fiber is added to the fibers to provide inter-fiber attachments to establish structure within the porous article which allows handling of the porous article prior to consolidation.

Thermoplastic fibers, which by definition become pliable or moldable above a specific temperature, are useful in the fiber network including polyimides such as polyetherimide and polyetherimide sulfone; polycarbonates including, polycarbonate-siloxane, polyestercarbonate, polyestercarbonate-siloxane; polyesters including polyethylene terephthalate and polybutylene terephthalate; or if flame performance and use temperatures are of minor importance, polyolefins such as polyethylene and polypropylene; polyamides and high performance polymers, such as polybenzimidazole or liquid crystalline polymers.

Polyimide fibers contribute one type of polymer to the polymer matrix. A wide variety of polyimides can be used, depending on the availability, melt temperature, and desired characteristics of the composites. As used herein, “polyimides” is inclusive of polyetherimides and polyetherimide sulfones. In an embodiment, the polyetherimides comprise more than 1, for example, 10 to 1000 or 10 to 500 structural units, of formula (1)

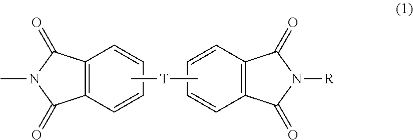

wherein each R is the same or different, and is a substituted or unsubstituted divalent organic group, such as a C₆₋₂₀ aromatic hydrocarbon group or a halogenated derivative thereof, a straight or branched chain C₂₋₂₀ alkylene group or a halogenated derivative thereof, a C₃₋₈ cycloalkylene group or halogenated derivative thereof, in particular a divalent group of formula (2)

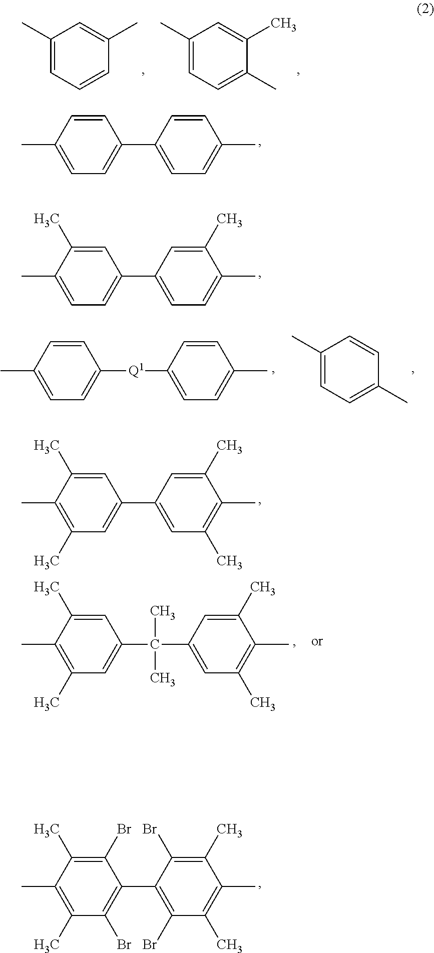

wherein Q¹ is —O—, —S—, —C(O)—, —SO₂—, —SO—, or —C_{y}H_{2y}— wherein y is an integer from 1 to 5 or a halogenated derivative thereof (which includes perfluoroalkylene groups). In an embodiment, R is an m-phenylene or p-phenylene.

Further in formula (1), T is —O— or a group of the formula —O—Z—O— wherein the divalent bonds of the —O— or the —O—Z—O— group are in the 3,3′,3,4′, 4,3′, or the 4,4′ positions. The group Z in —O—Z—O— of formula (1) is also a substituted or unsubstituted divalent organic group, and can be an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded. Exemplary groups Z include groups derived from a dihydroxy compound of formula (3):

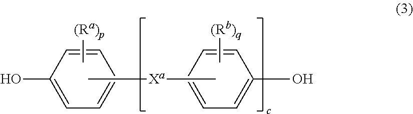

wherein R^{a} and R^{b} can be the same or different and are a halogen atom or a monovalent C₁₋₆ alkyl group, for example, p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (in one embodiment para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formulas (3a)

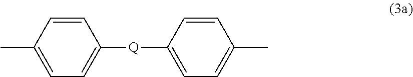

wherein Q is —O—, —S—, —C(O)—, —SO₂—, —SO—, or —C_{y}H_{2y}— wherein y is an integer from 1 to 5 or a halogenated derivative thereof (including a perfluoroalkylene group). In a specific embodiment, Z is derived from bisphenol A wherein Q in formula (3a) is 2,2-isopropylidene.

In an embodiment in formula (1), R is m-phenylene or p-phenylene and T is —O—Z—O wherein Z is a divalent group of formula (3a). Alternatively, R is m-phenylene or p-phenylene and T is —O—Z—O wherein Z is a divalent group of formula (3a) and Q is 2,2-isopropylidene.

In some embodiments, the polyetherimide can be a copolymer, for example, a polyetherimide sulfone copolymer comprising structural units of formula (1) wherein at least 50 mole % of the R groups are of formula (2) wherein Q¹ is —SO₂— and the remaining R groups are independently p-phenylene or m-phenylene or a combination comprising at least one of the foregoing; and Z is 2,2-(4-phenylene)isopropylidene. Alternatively, the polyetherimide optionally comprises additional structural imide units, for example, imide units of formula (4)

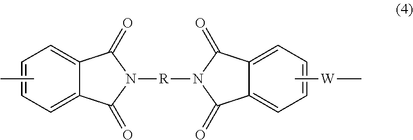

wherein R is as described in formula (1) and W is a linker of the formulas

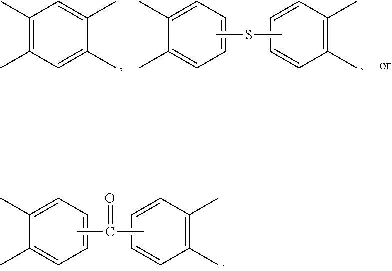

These additional structural imide units can be present in amounts from 0 to 10 mole % of the total number of units, 0 to 5 mole %, or 0 to 2 mole %. In an embodiment, no additional imide units are present in the polyetherimide.

The polyetherimide can be prepared by any of the methods well known to those skilled in the art, including the reaction of an aromatic bis(ether anhydride) of formula (4)

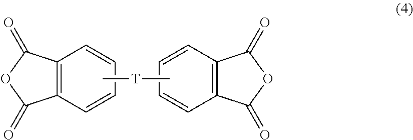

with an organic diamine of formula (5)

H₂N—R—NH₂ (5)

wherein T and R are defined as described above. Copolymers of the polyetherimides can be manufactured using a combination of an aromatic bis(ether anhydride) of formula (4) and a different bis(anhydride), for example, a bis(anhydride) wherein T does not contain an ether functionality, for example, T is a sulfone.

Illustrative examples of bis(anhydride)s include 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; and, 4-(2,3-dicarboxyphenoxy)-4′-(3,4-dicarboxyphenoxy)diphenyl sulfone dianhydride, as well as various combinations thereof.

Examples of organic diamines include ethylenediamine, propylenediamine, trimethylenediamine, diethylenetriamine, triethylene tetramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2, 2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1, 3-diamino-4-isopropylbenzene, bis(4-aminophenyl) sulfide, bis(4-aminophenyl) sulfone (also known as 4-[(4-aminobenzene)sulfonyl]aniline, sulfonyl dianiline, or diamino disulfone (DDS)), and bis(4-aminophenyl) ether. Combinations of these compounds can also be used. In some embodiments the organic diamine is m-phenylenediamine, p-phenylenediamine, DDS, or a combination comprising at least one of the foregoing.

The polyetherimides can have a melt index of 0.1 to 10 grams per minute (g/min), as measured by American Society for Testing Materials (ASTM) D1238 at 340 to 370° C., using a 6.7 kilogram (kg) weight. In some embodiments, the polyetherimide polymer has a weight average molecular weight (Mw) of 1,000 to 150,000 grams/mole (Dalton), as measured by gel permeation chromatography, using polystyrene standards. In some embodiments, the polyetherimide has an Mw of 10,000 to 80,000 Daltons. Such polyetherimide polymers typically have an intrinsic viscosity greater than 0.2 deciliters per gram (dl/g), or, 0.35 to 0.7 dl/g as measured in m-cresol at 25° C.

The thermoplastic fibers can be 5 to 75 millimeters (mm) in the longest dimension, 6 to 60 mm, 7 to 50 mm, or 10 to 40 mm in the longest dimension. In an embodiment, the diameter of the discontinuous reinforcing fibers can be 5 to 125 micrometers (μm), in an embodiment 10 to 100 micrometers. Thermoplastic fibers of submicron dimensions can also be used, for example, from 0.25 μm to 10 μm in diameter.

The optional polymer binder fibers contribute another polymer to the polymer matrix. The polymer binder fibers melt during formation of the porous mat, and are therefore selected to have a melt temperature lower than the melt temperature of the thermoplastic. For example, the polymer binder fibers can have a melt temperature that is at least 10° C. lower than the melt temperature of the thermoplastic, at least 20° C. lower, or at least 50° C. lower than the melt temperature of the thermoplastic. The polymer binder fiber is further selected so as to be compatible with the thermoplastic and the reinforcing fibers. The polymer binder further preferably is selected so as to not contribute significantly to the heat release, optical smoke density, and/or combustion products toxicity of the composites. Possible polymer binder fibers that can meet these criteria include thermoplastic polymers, such as silicone polymers, polyamides, polyesters, polycarbonates, polyestercarbonates, polyalphamethylstyrenes, polysulfones, and micron polyetherimide fibers (0.25 to 2 μm diameter fibers may be suitable as binder for polyetherimide), or a combination thereof. In an embodiment, the polymer binder is a polysiloxane-polyestercarbonate copolymer, polyester, polyester-polyetherimide blend, bicomponent fiber of any of the foregoing, or a combination thereof.

The polysiloxane-polyestercarbonate copolymer comprises siloxane units and arylate ester units that can comprise aromatic carbonate units.

The siloxane units are present in the copolymer in polysiloxane blocks, which comprise repeating siloxane units as in formula (10)

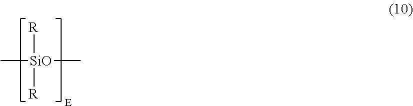

wherein each R is independently the same or different C₁₋₁₃ monovalent organic group. For example, R can be a C₁-C₁₃ alkyl, C₁-C₁₃ alkoxy, C₂-C₁₃ alkenyl group, C₂-C₁₃ alkenyloxy, C₃-C₆ cycloalkyl, C₃-C₆ cycloalkoxy, C₆-C₁₄ aryl, C₆-C₁₀ aryloxy, C₇-C₁₃ arylalkyl, C₇-C₁₃ aralkoxy, C₇-C₁₃ alkylaryl, or C₇-C₁₃ alkylaryloxy. The foregoing groups can be fully or partially halogenated with fluorine, chlorine, bromine, or iodine, or a combination thereof. In an embodiment, where a transparent polysiloxane-polycarbonate is desired, R is unsubstituted by halogen. Combinations of the foregoing R groups can be used in the same copolymer.

The value of E in formula (10) can vary depending on the type and relative amount of each component in the composition, the desired properties, and like considerations. Generally, E has an average value of 5 to 50, 5 to about 40, 10 to 30. In one embodiment, the polysiloxane blocks are of formula (11) or (12)

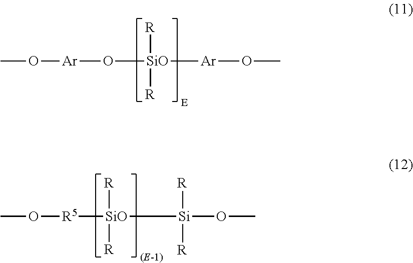

wherein E is as defined above and each R can be the same or different, and is as defined above. Ar can be the same or different, and is a substituted or unsubstituted C₆-C₃₀ arylene group, wherein the bonds are directly connected to an aromatic moiety. Ar groups in formula (11) can be derived from a C₆-C₃₀ dihydroxyarylene compound of formula (14) below, for example, 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulfide), and 1,1-bis(4-hydroxy-t-butylphenyl) propane. Combinations comprising at least one of the foregoing compounds can also be used. Each R⁵ is independently a divalent C₁-C₃₀ organic group, for example, a divalent C₂-C₈ aliphatic group.

In a specific embodiment, the polysiloxane blocks are of formula (13):

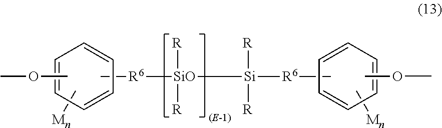

wherein R and E are as defined above; R⁶ is a divalent C₂-C₈ aliphatic group; each M can be the same or different, and can be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkylaryl, or C₇-C₁₂ alkylaryloxy, wherein each n is independently 0, 1, 2, 3, or 4. In an embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R² is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a combination of methyl and trifluoropropyl, or a combination of methyl and phenyl. In still another embodiment, M is methoxy, n is one, R² is a divalent C₁-C₃ aliphatic group, and R is methyl.

The polysiloxane-polyestercarbonate copolymer further comprises polyester blocks, in particular polyarylate ester blocks that optionally comprise carbonate units. The arylate ester units of the polyarylate ester blocks can be derived from the reaction product of one equivalent of an isophthalic acid derivative and/or terephthalic acid derivative with an aromatic dihydroxy compound of the formula HO—R¹—OH, in particular of formula (14) or (15).

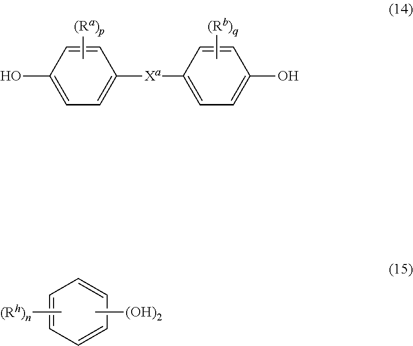

In formula (14), R^{a} and R^{b} are each independently a halogen atom or a monovalent hydrocarbon group; p and q are each independently integers of 0 to 4; and X^{a} is a bridging group connecting the two hydroxy-substituted aromatic groups, where the bridging group and the hydroxy substituent of each C₆ arylene group are disposed ortho, meta, or para (in an embodiment para) to each other on the C₆ arylene group. In an embodiment, the bridging group X^{a} is —C(R^{c})(R^{d})— or —C(═R^{e}) (wherein R^{c} and R^{d} each independently is a hydrogen atom or a monovalent linear or cyclic hydrocarbon group and R^{e} is a divalent hydrocarbon group), a single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In one embodiment, p and q is each 1, and R^{a} and R^{b} are each a C₁₋₃ alkyl group, for example methyl, disposed meta to the hydroxy group on each arylene group. In another embodiment, X^{a} is a C₁₋₁₈ alkylene group, a C₃₋₁₈ cycloalkylene group, a fused C₆₋₁₈ cycloalkylene group, or a group of the formula —B¹—W—B²— wherein B¹ and B² are the same or different C₁₋₆ alkylene group and W is a C₃₋₁₂ cycloalkylidene group or a C₆₋₁₆ arylene group.

In formula (15), wherein each R^{h} is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0 to 4. The halogen is usually bromine.

Illustrative examples of specific aromatic dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or combinations comprising at least one of the foregoing dihydroxy compounds.

Specific examples of bisphenol compounds of formula (14) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). Specific examples of compounds of formula (15) include 5-methyl resorcinol, hydroquinone, and 2-methyl hydroquinone. Combinations comprising at least one of the foregoing dihydroxy compounds can also be used.

The polyarylate ester blocks can comprise 100 mole % (mol %) of arylate ester units as illustrated in formula (16):

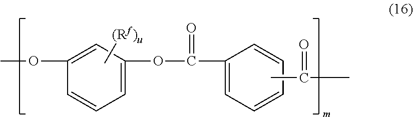

wherein R^{f} and u are previously defined for formula (15), and m is greater than or equal to 4. In embodiments, m is 4 to 50, 5 to 30, 5 to 25, or 10 to 20. Also in an embodiment, m is less than or equal to 100, less than or equal to 90, less than or equal to 70, or less than or equal to 50. It will be understood that the low and high endpoint values for m are independently combinable. In another embodiment, the molar ratio of isophthalate to terephthalate can be about 0.25:1 to about 4.0:1.

Exemplary arylate ester units are aromatic polyester units such as isophthalate-terephthalate-resorcinol ester units, isophthalate-terephthalate-bisphenol A ester units, or a combination thereof. Specific arylate ester units include poly(isophthalate-terephthalate-resorcinol) esters, poly(isophthalate-terephthalate-bisphenol-A) esters, poly[(isophthalate-terephthalate-resorcinol) ester-co-(isophthalate-terephthalate-bisphenol-A)] ester, or a combination thereof. In an embodiment, a useful arylate ester unit is a poly(isophthalate-terephthalate-resorcinol) ester. In an embodiment, the arylate ester unit comprises isophthalate-terephthalate-resorcinol ester units in an amount greater than or equal to 95 mol %, greater than or equal to 99 mol %, or greater than or equal to 99.5 mol % based on the total number of moles of ester units in the polyarylate unit. In another embodiment, the arylate ester units are not substituted with non-aromatic hydrocarbon-containing substituents such as, for example, alkyl, alkoxy, or alkylene substituents.

Alternatively, the polyarylate ester blocks are polyestercarbonate blocks that comprise arylate ester units and carbonate units shown in formula (17):

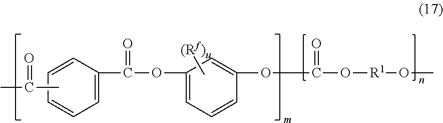

wherein R^{f}, u, and m are as defined in formula (16), each R¹ is independently an aromatic dihydroxy compound of the formula HO—R¹—OH, in particular of formula (14) or (15), and n is greater than or equal to one. In embodiments, m is from 3 to 50, from 5 to 25, from 5 to 20; and n is less than or equal to 50, less than or equal to 25, less than or equal to 20. It will be understood that the endpoint values for n are independently combinable. In an embodiment, m is from 5 to 75, from 5 to 30, from 10 to 25, and n is less than 20. In a further embodiment, m is 5 to 75, and n is 3 to 50; or m is 10 to 25, and n is 5 to 20. In an embodiment, the molar ratio of the isophthalate-terephthalate ester units to the carbonate units in the polyestercarbonate block can be 100:0 to 50:50, 95:5 to 60:40, or 90:10 to 70:30.

In another embodiment, the polyestercarbonate unit comprises bisphenol carbonate units of formula (18) (derived from bisphenols of formula (14) and/or resorcinol carbonate units of formula (19) (derived from resorcinols of formula (15):

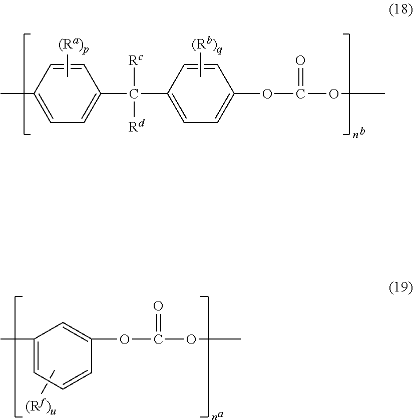

wherein R^{a} and R^{b} are each individually C₁₋₈ alkyl, R^{c} and R^{d} are individually C₁₋₈ alkyl or C₁₋₈ cycloalkylene, p and q are 0 to 4, and n^{b} is greater than or equal to one; and wherein R^{f} and u are as described above, and n^{a} is greater than or equal to 1. The polyestercarbonate units comprise a molar ratio of bisphenol carbonate units of formula (18) to resorcinol carbonate units of formula (19) of 0:100 to 99:1, or 20:80 to 80:20. In another embodiment, the polyestercarbonate blocks are derived from resorcinol (i.e., 1,3-dihydroxybenzene), or a combination comprising resorcinol and bisphenol-A, for example, the polyestercarbonate block is a poly(isophthalate-terephthalate-resorcinol ester)-co-(resorcinol carbonate)-co-(bisphenol-A carbonate).

In an embodiment, the polyestercarbonate blocks of the polysiloxane-polyestercarbonate copolymer consist of 50 to 100 mol % of arylate ester units, 58 to 90 mol % arylate ester units; 0 to 50 mol % aromatic carbonate units (e.g., resorcinol carbonate units, bisphenol carbonate units and other carbonate units such as aliphatic carbonate units); 0 to 30 mol % resorcinol carbonate units, 5 to 20 mol % resorcinol carbonate units; and 0 to 35 mol % bisphenol carbonate units, or 5 to 35 mol % bisphenol carbonate units.

The polyestercarbonate unit can have an M_{w} of 2,000 to 100,000 g./mol, 3,000 to 75,000 g./mol, 4,000 to 50,000 g./mol, 5,000 to 35,000 g./mol, or 17,000 to 30,000 g./mol. Molecular weight determinations are performed using GPC using a crosslinked styrene-divinyl benzene column, at a sample concentration of 1 milligram per milliliter, and as calibrated with polycarbonate standards. Samples are eluted at a flow rate of about 1.0 ml/min with methylene chloride as the eluent.

The polysiloxane-polyestercarbonate copolymers can be manufactured by methods known in the art, for example, reaction of the corresponding dihydroxy compounds of formulas (11), (12), and (13) with dicarboxylic acid derivatives and dihydroxy compounds of formulas (14) and (15) by different methods such as solution polymerization, interfacial polymerization, and melt polymerization. For example, the polysiloxane-polyestercarbonate copolymer can be prepared by interfacial polymerization, such as by the reaction of a diacid derivative, a difunctional polysiloxane polymer, a dihydroxy aromatic compound, and where desired, a carbonyl source, in a biphasic medium comprising an immiscible organic phase and aqueous phase. The order and timing of addition of these components to the polymerization reaction can be varied to provide a polysiloxane-polyestercarbonate copolymer having different distributions of the polysiloxane blocks in the polymer backbone. The polysiloxane can be distributed within the ester units in the polyester units, the carbonate units in the polycarbonate units, or both. Proportions, types, and amounts of the reaction ingredients can be selected by one skilled in the art to provide polysiloxane-polyestercarbonate copolymers having specific desirable physical properties for example, heat release rate, low smoke, low toxicity, haze, transparency, molecular weight, polydispersity, glass transition temperature, impact properties, ductility, melt flow rate, and weatherability.

In an embodiment, the polysiloxane-polyestercarbonate copolymer can comprise siloxane units in an amount of 0.5 to 20 mol %, 1 to 10 mol % siloxane units, based on the combined mole percentages of siloxane units, arylate ester units, and optional carbonate units, and provided that siloxane units are provided by polysiloxane units covalently bonded in the polymer backbone of the polysiloxane-polyestercarbonate copolymer composition. The polysiloxane-polyestercarbonate copolymer comprises siloxane units in an amount of 0.2 to 10 weight percent (wt. %), 0.2 to 6 wt. %, 0.2 to 5 wt. %, or 0.25 to 2 wt. %, based on the total weight of the polysiloxane-polyestercarbonate copolymer, with the proviso that the siloxane units are provided by polysiloxane units covalently bonded in the polymer backbone of the polysiloxane-polyestercarbonate copolymer. In another embodiment, the copolymer further comprises 0.2 to 10 wt. % siloxane units, 50 to 99.8 wt. % ester units, and 0 or more than 0 to 49.85 wt. % carbonate units; or 0.3 to 3 wt. % polysiloxane units, 60 to 96.7 wt. % ester units, and 3 to 40 wt. % carbonate units, wherein the combined weight percentages of the polysiloxane units, ester units, and carbonate units is 100 wt. % of the total weight of the polysiloxane-polyestercarbonate copolymer composition.

The polysiloxane-polyestercarbonate copolymers can have an intrinsic viscosity, as determined in chloroform at 25° C., of 0.3 to 1.5 deciliters per gram (dl./g.), or 0.45 to 1.0 dl./g. The polysiloxane-polyestercarbonate copolymers can have a weight average molecular weight (M_{w}) of 10,000 to 100,000 g./mol, as measured by gel permeation chromatography (GPC) using a crosslinked styrene-divinyl benzene column, at a sample concentration of 1 milligram per milliliter, and as calibrated with polycarbonate standards.

In an embodiment, the polysiloxane-polyestercarbonate copolymer has flow properties described by the melt volume flow rate (MVR), which measures the rate of extrusion of a thermoplastic polymer through an orifice at a prescribed temperature and load. Polysiloxane-polyestercarbonate copolymers suitable for use can have an MVR, measured at 300° C. under a load of 1.2 kg according to ASTM D1238-04, of 0.5 to 80 cubic centimeters per 10 minutes (cc./10 min.). In a specific embodiment, an exemplary polycarbonate has an MVR measured at 300° C. under a load of 1.2 kg according to ASTM D1238-04, of 0.5 to 100 cc./10 min., 1 to 75 cc./10 min., or 1 to 50 cc./10 min. Combinations of polycarbonates of different flow properties can be used to achieve the overall desired flow property. The polysiloxane-polyestercarbonate copolymer can have a T_{g} of less than or equal to 165° C., less than or equal to 160° C., or less than or equal to 155° C. The polysiloxane-polyestercarbonate copolymer can have a T_{g} for the polycarbonate unit of greater than or equal to 115° C., or greater than or equal to 120° C. In an embodiment, the polysiloxane-polyestercarbonate copolymer has a melt volume rate (MVR) of 1 to 30 cc./10 min., or 1 to 20 cc./10 min., when measured at 300° C. under a load of 1.2 kg. according to ASTM D1238-04, and a T_{g} of 120 to 160° C., 125 to 155° C., or 130 to 150° C.

Still further in an embodiment, the polysiloxane-polyestercarbonate copolymer composition has a 2 minute integrated heat release rate of less than or equal to 65 kilowatt-minutes per square meter (kW-min./m.²) and a peak heat release rate of less than 65 kilowatts per square meter (kW./m.²) as measured using the method of FAR F25.4, in accordance with Federal Aviation Regulation FAR 25.853 (d). Polysiloxane-polyestercarbonate copolymers are commercially available from SABIC Innovative Plastics, Pittsfield, Mass.

Prior to being formed into fibers, the selected polymers can be formulated with various additives ordinarily incorporated into polymer compositions of this type, with the proviso that the additives are selected so as to not significantly adversely affect the desired properties of the fibers or fiber spinning process. Exemplary additives include fillers, catalysts (for example, to facilitate reaction between an impact modifier and the polyester), antioxidants, thermal stabilizers, light stabilizers, ultraviolet light (UV) absorbing additives, quenchers, plasticizers, lubricants, mold release agents, antistatic agents, visual effect additives such as dyes, pigments, and light effect additives, flame resistances, anti-drip agents, and radiation stabilizers. Combinations of additives can be used. The foregoing additives (except any fillers) are generally present in an amount from 0.005 to 10 wt. %, or 0.01 to 5 wt. %, based on the total weight of the composition.

In a specific embodiment, certain flame retarding agents are excluded from the compositions, in particular, flame retardants that include phosphorus, bromine, and/or chlorine. Non-brominated and non-chlorinated phosphorus-containing flame retardants can be preferred in certain applications for regulatory reasons, for example, organic phosphates. In another specific embodiment, inorganic flame retardants are excluded from the compositions, for example, salts of C₁₋₁₆ alkyl sulfonate salts such as potassium perfluorobutane sulfonate (Rimar salt), potassium perfluorooctane sulfonate, tetraethyl ammonium perfluorohexane sulfonate, and potassium diphenylsulfone sulfonate, and the like; salts formed by reacting for example, an alkali metal or alkaline earth metal (for example, lithium, sodium, potassium, magnesium, calcium, and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or fluoro-anion complexes such as Li₃AlF₆, BaSiF₆, KBF₄, K₃AlF₆, KAlF₄, K₂SiF₆, and/or Na₃AlF₆ or the like.

The thermoplastic and optional polymer binders may be formed into fibers by means known in the art. These fibers, together with the reinforcing fibers are combined to provide a composition for the production of a porous article such as a mat. Consolidation of the porous article is conducted under heat and pressure, and cooled under heat and pressure, to provide a composite that can then be thermoformed to provide articles useful in the manufacture of interior aircraft panels, for example.

In particular, a composition for the manufacture of a porous, compressible article such as a mat includes a combination of a plurality of reinforcing fibers; a plurality of thermoplastic fibers; and optionally a plurality of polymeric binder fibers wherein the polymeric binder fibers have a melting point lower than the thermoplastic fibers. When the binder fiber is present, the composition is thermally treated to selectively melt and flow the polymer binder fibers such that the polymer binder adheres adjoining fibers together upon cooling, to produce a mat containing a network of discontinuous, randomly oriented reinforcing fibers and thermoplastic fibers bonded together using melted fibers of the polymer binder. The porous mat is then thermally treated under pressure to melt and flow the thermoplastic fibers such that the thermoplastic composition adheres adjoining fibers together upon cooling. In this way, an interconnected network of reinforcing fibers and a polymer matrix (dual polymer matrix when optional polymer binder is included) is formed. The network so prepared has high loft and uniformity of loft across the structure.

A method for forming a porous mat accordingly includes forming a layer comprising a suspension of the combination of a plurality of reinforcing fibers; a plurality of thermoplastic fibers; and optionally a plurality of polymeric binder fibers in a liquid, for example, an aqueous fluid; at least partially removing the liquid from the suspension to form a web; heating the web under conditions sufficient to remove any remaining aqueous fluid from the web and to melt the polymeric binder fibers if present, or if no binder fiber is present at least some of the thermoplastic fiber is melted to act as the binder (optionally, thermoplastic micro fiber may also be usable as binder fiber or matrix resin fiber); and cooling the heated web to form the porous mat, wherein the porous mat comprises a network of the reinforcing fibers and the thermoplastic fibers, optionally in a matrix of the polymeric binder.

The reinforcing fibers, thermoplastic fibers, and optional polymeric binder fibers are combined in a liquid medium to form a suspension, wherein the fibers are substantially uniformly suspended and distributed throughout the medium. In one embodiment, the combining is performed by introducing the fibers into an aqueous medium to provide a suspension, which can be a slurry, dispersion, or emulsion. The combining is performed so as to render the fibers substantially evenly dispersed in the aqueous medium, and can use agitation to establish and maintain the dispersion of these components. The suspension can further comprise additives such as dispersants, buffers, anti-coagulants, surfactants, and the like, and combinations thereof, to adjust or improve the flow, dispersion, adhesion, or other properties of the suspension. The suspension can be a foamed suspension comprising the fibers, water, and a surfactant. The percentage by weight of solids of the suspension can be from 0.1 to 99 wt. %, 2 to 50 wt. %., or 0.05 to 10 wt. %. Additives can be present in an amount effective for imparting desired properties of foaming, suspension, flow, and the like.

The suspension can be prepared in batch mode, and used directly or stored for later use, or alternatively be formed in a continuous manufacturing process wherein the components are each combined to form the suspension at a time just prior to the use of the suspension.

To form a porous article such as a mat, the suspension is applied as a slurry to a porous surface, for example, a wire mesh, and the liquid and suspended components too small to remain on the porous surface are removed through the porous surface by gravity or use of vacuum, to leave a layer comprising a dispersion of fibers on the porous surface. In an exemplary embodiment, the porous surface is a conveyor belt having pores, and of dimensions suitable to provide, after application of the dispersed medium and removal of liquid, a fibrous mat having a width of 2 meters and of continuous length. The dispersed medium can be contacted to the porous surface by distribution through a head box, which provides for application of a coating of the dispersed medium having a substantially uniform width and thickness over the porous surface. Typically, vacuum is applied to the porous surface on a side opposite the side to which the dispersed medium is applied, to draw the residual liquid and/or small particles through the porous surface, thereby providing a web in substantially dried form. In an embodiment, the layer is dried to remove moisture by passing heated air through the layer mat preferably in a downward draft oven to keep from dispersing the fibers.

Upon removal of the excess dispersed medium and/or moisture, the non-bonded, web comprising the fibers is thermally treated to form a porous article, for example, a mat. In an embodiment, the web is heated by passing heated air through the web in a forced-hot-air-oven. In this way, the web can be dried using air heated at a temperature of greater than or equal to, e.g., 100° C. under a flow of air.

The heating temperature to form the porous mat is selected based upon the properties of the polymers employed in a given embodiment. In embodiments that employ the optional binder, the heating temperature is selected to substantially soften and melt the polymer binder, but not the thermoplastic fiber, for example, at a temperature from 130 to 170° C. In an embodiment, the heating comprises heating in an oven at a temperature from 130 to 150° C., then infrared heating at a temperature from 150 to 200° C. During heating of the web, the polymer binder melts and flows to form a common contact (e.g., a bridge) between two or more of the reinforcing and thermoplastic fibers, and forms an adhesive bond with the fibers upon cooling to a non-flowing state, thereby forming the porous article.

In embodiments that do not employ the optional binder, the heating temperature to form the porous mat is selected to substantially soften and melt the thermoplastic fiber matrix and form attachment points between fibers, for example, at a temperature from 230 to 270° C. In an embodiment, the heating comprises drying in an oven at a temperature from 130 to 150° C., then infrared heating at a temperature from 250 to 270° C. for a short time for polyetherimide fiber matrix, or at a lower temperature for polymer matrices having a lower softening temperature. A roller nip can also be used to improve adhesion of the softened fibers. During heating of the web thermoplastic, some of the fibers soften and adhere to other fibers to form a connection at points of contact (e.g., a bridge) between two or more of the reinforcing and thermoplastic fibers, and forming an adhesive bond with the fibers upon cooling to a non-flowing state, thereby forming the porous article.

The porous article comprises a network of the plurality of reinforcing fibers and the plurality of thermoplastic fibers. The porous article can have an areal weight of from 50 to 500 g./m.². Alternatively, or in addition, the porous article has a porosity of greater than about 0%, more particularly about 5% to about 95%, and still more particularly about 20% to about 80% by volume.

A composite is formed from the porous article, by heating and compressing at least one of the porous articles under conditions sufficient to melt the thermoplastic fibers and consolidate the network; and cooling the heated, compressed article under pressure to form the composite comprising a network comprising a plurality of reinforcing fibers; and a matrix comprising melted and cooled thermoplastic fibers, and melted and cooled polymeric binder fibers, wherein the polymeric binder has a melt temperature lower than the thermoplastic. The matrix and any binder fiber are substantially fully melted and little evidence of their fibrous nature typically remains once compressed and cooled.

During thermoforming, heating is at a temperature effective to soften the polyimide, for example, a temperature of 300 to 385° C., or 330 to 365° C., and a pressure of 1 bar to 15 bar, or 3 bar to 8 bar. During heating of the porous article, the polyimide softens and may flow to form a common contact (e.g., a bridge) between two or more of the reinforcing fibers, and forms an adhesive bond with the fibers upon cooling to a non-flowing state, thereby forming the composite. Heat-treating and compression can be by a variety of methods, for example, using double belt laminators, indexing presses, multiple daylight presses, autoclaves, and other such devices used for lamination and consolidation of sheets so that the thermoplastic can flow and wet out the fibers. The gap between the consolidating elements in the consolidation devices may be set to a dimension less than that of the unconsolidated web and greater than that of the web if it were to be fully consolidated, thus allowing the web to expand and remain substantially permeable after passing through the rollers. In one embodiment, the gap is set to a dimension about 5% to about 10% greater than that of the web if it were to be nearly fully consolidated (full consolidation is likely to break a large percentage of the reinforcing fibers thus reducing both the lofting and the mechanical properties of the sheet especially after forming). It may also be set to provide a nearly fully consolidated web that is later re-lofted and molded to form particular articles or materials. A fully consolidated web means a web that is fully compressed and substantially void free, but may have poor mechanical and lofting performance. A fully consolidated web would have less than about 5% void content and have negligible open cell structure.

In an embodiment, the article is a mat. Two or more mats can be stacked and heated treated under compression, for example 2 to 12 mats, 3 to 11 mats, 4 to 9 mats, 5 to 8 mats, or 6 to 7 mats.

In an advantageous feature, the composite has a minimum degree of loft of greater than or equal to three. In another advantageous feature, the loft of the composite is within one sigma, over the entirety of the composite. Alternatively, or in addition, the loft of the composite is within 30%, over the entirety of the composite. Loft can be understood as the expansion that the composite sheet undergoes as it is reheated without pressure to the processing temperature of the thermoplastic, compared to the thickness of the fully consolidated sheet. It indicates primarily the degree of stress in the reinforcing fiberglass, the viscosity of the matrix resin as well as fiber attrition that occurred during consolidation, which provides an indication of mechanical strength and formability. Manufacturing cycle time of the product is shortened considerably, from several hours down to minutes.

The porosity of the composite is generally less than about 10 volume % or a minimum of about 5% or sufficient to permit drawing a vacuum through the composite to form and attach a decorative surface film.

In a specific embodiment, a composite includes a network comprising a plurality of reinforcing fibers selected from metal fibers, metallized inorganic fibers, glass fibers, graphite fibers, carbon fibers, ceramic fibers, mineral fibers, basalt fibers, and polymer fibers having a melt temperature at least 150° C. higher than the thermoplastic, and combinations thereof; and a matrix comprising: (a) melted and cooled polyimide fibers and (b) melted and cooled optional polymeric binder fibers, wherein the polymeric binder has a melt temperature lower than the thermoplastic, and wherein the composite has a minimum degree of loft of greater than or equal to three, and the loft of the composite is within 30% over the entirety of the composite. In an embodiment, the composite does not include a perfluoroalkyl sulfonate salt, a fluoropolymer encapsulated vinylaromatic copolymer, potassium diphenylsulfone-3-sulfonate, sodium trichlorobenzenesulfonate, or a combination comprising at least one of the foregoing flame retardants.

Layers of thermoplastic material, woven and non-woven fabrics and the like, can optionally be laminated to the composite to form a structure having two or more layers. Lamination is effected by feeding one or more optional top layers of material, and/or one or more bottom layers of material, into a nip roller simultaneously with the composite. The nip roller temperature may be controlled to about 200° C., and can provide temperature control for the heated structure during application of pressure, and thus during formation of the composite. The roller pressure for compressing and/or compacting the fibrous mat and/or additional layers can be adjusted to maximize the final properties of the structure.

If not consolidated directly after preparation, the composite or layered structure prepared therefrom can be folded (fastooned) (for example, up to 2 layers), or rolled.

Structures containing more layers can be rolled onto very large diameter rollers, about as many feet in diameter as the number of layers thick. Accordingly, structures over 8 layers thick would require very large equipment to roll them. Consolidated product of 1 to at least 4 layers can be rolled onto cores of 6″-12″ diameter and be shipped to the customer, who would be able to cut the sheet lengths chosen for optimal yield even being able to remove a defective section without losing a whole sheet. The composite or layered structure can also be sheared into sheets. The cut composite and/or the layered structure can be molded and expanded to form an article of a desired shape, for use in manufacture of further articles. The intermediate rolled, folded, or sheeted composite or layered structure can further be molded into an article of a suitable shape, dimension, and structure for use in further manufacturing processes to produce further articles.

While any suitable method of forming an article using the composite is contemplated, in a particular embodiment, the composite is advantageously formed into an article by thermoforming, which can reduce the overall cost in manufacturing the article. It is generally noted that the term “thermoforming” is used to describe a method that can comprise the sequential or simultaneous heating and forming of a material onto a mold at below the Tg of the resin, wherein the material is originally in the form of a film, sheet, layer, or the like, and can then be formed into a desired shape. Once the desired shape has been obtained, the formed article (e.g., a component of an aircraft interior such as a panel) is cooled below its melt or glass transition temperature. Exemplary thermoforming methods can include, but are not limited to, mechanical forming (e.g., matched tool forming), membrane assisted pressure/vacuum forming, membrane assisted pressure/vacuum forming with a plug assist, and the like. It can be noted the greater the draw ratio, the greater the degree of lofting needs to be, to be able to form a part of uniform thickness. Variable thickness can actually be used as a design feature by increasing the thickness for extra stiffness or increasing the compression for extra strength as where a fastener is required.

In an embodiment, the composites and articles formed from the composites meet certain flame retardant properties presently required by the airline transportation industry. In an embodiment, the composite and articles comprising the composite (including a thermoformed sheet and an interior airplane component, and other articles disclosed herein) can exhibit at least one of the following desirable properties: (1) a peak heat release of less than 65 kW./m.², as measured by FAR 25.853 (OSU test); (2) a total heat release at 2 minutes of less than or equal to 65 kW-min./m.² as measured by FAR 25.853 (OSU test), (3) an NBS (National Board of Standards) optical smoke density of less than 200 when measured at 4 minutes, based on ASTM E-662 (FAR/JAR 25.853). In an embodiment, all three of the foregoing properties are met.

In a specific embodiment, an article includes a thermoformed composite, wherein the composite includes a network comprising a plurality of reinforcing fibers selected from metal fibers, metallized inorganic fibers, metallized synthetic fibers, glass fibers, graphite fibers, carbon fibers, ceramic fibers, mineral fibers, basalt fibers, polymer fibers having a melt temperature at least 150° C. higher than the thermoplastic, and combinations thereof; and a matrix comprising: (a) melted and cooled polyimide fibers and (b) melted and cooled polymeric binder fibers, wherein the polymeric binder has a melt temperature lower than the thermoplastic, and wherein the composite has a minimum degree of loft of greater than or equal to three and the loft of the composite is within 30% over the entirety of the composite.

In another embodiment, the combustion products can be nontoxic, that is, the composite and articles formed therefrom have toxic emissions levels to pass the requirements for toxicity described in Airbus Test Specifications ATS 1000.0001 and ABD 0031, and Boeing Standard Specification BSS 7239. In an embodiment, the composites can have a toxic gases release of less than or equal to 100 ppm based on Draeger Tube Toxicity test (Airbus ABD0031, Boeing BSS 7239). In another embodiment, the composites can have, as determined using a Draeger tube, for flaming conditions, less than 150 parts per million (ppm) hydrogen cyanide (HCN), less than 3,500 ppm carbon monoxide (CO), less than 100 ppm nitrogen oxides (NO and NO₂), less than 100 ppm sulfur dioxide (SO₂), and less than 150 ppm hydrogen chloride (HCl); and for non-flaming conditions, less than 150 parts per million (ppm) hydrogen cyanide (HCN), less than 3,500 ppm carbon monoxide (CO), less than 100 ppm nitrogen oxides (NO and NO₂), less than 100 ppm sulfur dioxide (SO₂), and less than 150 ppm hydrogen chloride (HCl).

Those skilled in the art will also appreciate that common curing and surface modification processes including but not limited to heat-setting, texturing, embossing, corona treatment, flame treatment, plasma treatment, and vacuum deposition can further be applied to the above articles to alter surface appearances and impart additional functionalities to the articles. Additional fabrication operations can be performed on articles, such as, but not limited to molding, in-mold decoration, baking in a paint oven, lamination, hard coating and molded on attachment features.

Articles prepared from these composites include those used to fabricate interior panels for aircraft, trains, automobiles, passenger ships, and the like, and are useful where good thermal and sound insulation are desired. Articles include aircraft parts including oxygen mask compartment covers; and thermoformed and non-thermoformed articles prepared from sheets of the composites such as light fixtures; lighting appliances; light covers, cladding or seating for public transportation; cladding or seating for trains, subways, or buses; meter housings; and like applications. Other specific applications include window shades, air ducts, compartments and compartment doors for storage and luggage, tray tables, oxygen mask compartment parts, air ducts, window trim, and other parts such as panels used in the interior of aircraft, trains or ships.

The invention is further illustrated by the following non-limiting examples.

### EXAMPLES

The purpose of these Examples was to evaluate the performance of a thermoformable composite made from a combination of: (a) a fibrous filler component comprising a plurality of reinforcing fibers, (b) a fibrous thermoplastic fiber component comprising a plurality of thermoplastic fibers, and (c) an optional binder component comprising a plurality of polymeric binder fibers having a melt temperature lower than the thermoplastic fibers. In some embodiments, such composites meet all of the following requirements: (1) a peak heat release of less than 65 kW/m², as measured by FAR 25.853 (OSU test); (2) a total heat release at 2 minutes of less than or equal to 65 kW-min./m.² as measured by FAR 25.853 (OSU test), (3) an NBS optical smoke density of less than 200 when measured at 4 minutes, based on ASTM E-662 (FAR/JAR 25.853).

### Materials

The following materials were used in the Examples.

| MATERIAL | DESCRIPTION | SOURCE |
|---|---|---|
| Polyimide | | SABIC |
| fibers | | |
| LEXAN FST | Polysiloxane-polyestercarbonate | SABIC |
| fibers | copolymer fibers with polysiloxane units | |
| | having 4-50 siloxane units, and | |
| | polyestercarbonate units with 50 to 100 mol | |
| | % of arylate ester units, less than 50 mol | |
| | % aromatic carbonate units, less than | |
| | 30 mol % resorcinol carbonate units, and | |
| | less than 35 mol % bisphenol A carbonate | |
| | units | |
| Chopped Glass | ~½″ long, diameter of ~12 to 23 micron | OCF |
| fibers | | |
| Continuous | Strands of several hundred fibers 10 to | OCF |
| Carrier | 13 micron thick | |
| fibers | | |
| Carrier Layer | Lightweight (17 g/m²) glass fabric (106 | BFG |
| (scrim) | Weave) | |

### Techniques/Procedures

### Procedure for Determining Peak Heat Release and Total Heat Release at Two Minutes, as Measured by FAR 25.853 (OSU Test).

Heat release testing was performed using the Ohio State University (OSU) rate-of-heat release apparatus, by the method listed in FAR 25.853 (d), and in Appendix F, section IV (FAR F25.4). Peak heat release was measured as kW/m² (kilowatts per square meter). Total heat release was measured at the two minute mark in kW-min./m.² (kilowatt minutes per square meter). The heat release test method is also described in the “Aircraft Materials Fire Test Handbook” DOT/FAA/AR-00/12, Chapter 5 “Heat Release Test for Cabin Materials.”

### Procedure for Determining the NBS Optical Smoke Density at 4 Minutes, Based on ASTM E-662 (FAR/JAR 25.853).

Smoke density testing can be performed according to the method listed in FAR 25.853 (d), and in Appendix F, section V (FAR F25.5). Smoke density was measured under flaming mode. Smoke density at 4.0 minutes was determined.

Procedure for Draeger Tube Toxicity Testing.

Draeger tube toxicity of gases testing can be performed according to Airbus ABD0031 (also Boeing BSS 7238).

Procedure for Forming a Thermoformable Composite.

The composite was made according to the following process. The reinforcing fibers, polyimide fibers, and polymeric binder fibers were mixed in an aqueous slurry to form an aqueous suspension of the fiber mixture. The aqueous suspension was deposited on a wire mesh to form a layer, and water was drained from the layer to form a web.

The web was heated under conditions sufficient to remove any residual water and melt the binder fibers to form a matrix that was deposited onto the reinforcing and polyimide fiber surfaces, thereby forming a porous mat.

In the Comparative Examples, one or more layer(s) of the porous mat(s) were transferred onto a scrim carrier layer and the mat(s) on the scrim carrier layer were consolidated as described below.

In the Examples of the Invention, continuous carrier fibers were directed along a surface of a porous mat to provide an array of spaced, continuous carrier fibers running along the surface of the mat. The spaced continuous carrier fibers were applied to the porous mat as yarn (yarn being the term for a bundle of fibers that is twisted together to hold them together for easy control) in the machine direction, as illustrated in FIG. 1. Alternatively, the carrier fiber can be applied to the porous mat in a diagonal traversing pattern, as illustrated in FIG. 2, in which the fiber traverses major portions of the width of the surface at an angle to the machine direction, and upon traversing its full sideward path of travel, returns back across the surface at an angle inclined toward the opposite edge of the surface of the porous mat.

The mats, once consolidated are the sheet that is reheated and formed. The carrier strands may be placed on top of a mat, between layers of mats, or under the bottom most layer of mat and consolidated (only once to minimize reinforcing and carrier fiber attrition) under conditions sufficient to melt the polyimide and compress the mat to form the thermoformable composite, such that the polyimide melted onto the reinforcing fiber surfaces and voids were minimized in number and size by compression and cooling under pressure to provide low porosity to the finished composite sheet.

### Test to Determining Loft of Thermoformable Composite.

The following test procedure was used for determining degree of loft.

1. A 6 inch strip of the sheet was sheered for sampling from the consolidated sheet consolidated as described above once steady state of the consolidation was achieved.

2. Two-inch (50.8 mm) wide samples of the strip were cut. The samples were marked with sample numbers and the thickness was measured at 10 marked locations.

3. Subsequently the samples were placed in an oven at 380° C. for 5 minutes.

4. After cooling, the thickness of all previously measured points of the samples was re-measured, averaged, and the ratios of the thickness after and before were recorded for each sample as degree of loft. Thickness and variability of thickness and degree of lofting were also calculated and recorded.

The degree of loft is a measure of how much the composite sheet expands and develops porosity on reheating substantially above the melt temperature of the matrix. Without being bound by theory, it is believed that expansion of the composite sheet is due to the reinforcing fibers being bent and trapped during consolidation and cooling. As the sheet is reheated (for example, during thermoforming), the reinforcing fibers can straighten as the viscosity of the matrix resin drops with increasing temperature. The extent to which the sheet can expand during heating (loft) is an indication of how well the sheet can be thermoformed. Too high a pressure or too low a temperature during consolidation will cause excessive breakage of the reinforcing fibers, resulting in poor expansion and reduced mechanical properties. Loft does not substantially affect the FST properties of the composite.

Procedure for Thermoforming the Composite into an Article.

The composite sheet was cut to the desired size and clamped into a clamp frame in a thermoformer. There it was exposed to heat from an emitter to bring the sheet to the proper forming temperature, e.g., about 365° C. The tool, at a temperature of, e.g., about 175° C., was then closed around the hot sheet. After approximately 1 minute, the cooled, formed part was removed from the tool and prepared for pulling the decorative surface film over the part.

The formed part is prepared for application of a decorative film by trimming the formed part to the final desired dimension. Additional surface treatment such as filling, sanding, and priming can be used, but in an advantageous feature, are not required. The trimmed, formed part is then returned to the vacuum side of the tool (usually the bottom half). A decorative film is placed into the clamp frame and heated to a forming temperature, e.g., 140° C. to 170° C., at which point the film is pulled onto the trimmed part by bringing the trimmed part into contact with the hot film and drawing a vacuum through the lower half of the tool to remove any entrapped air. There is sufficient latent heat in the film, which contains hot melt adhesive on the underside to conform to the trimmed, formed part and bond securely to its surface. Upon cooling the part is ready for inspection.

Preparation of Consolidated Sheets.

Composites in the form of a consolidated sheet were made in accordance to the procedure above, using the same wt. % of glass fibers, polyimide fibers, and polysiloxane-polyestercarbonate copolymer fibers. Pressure during consolidation and loft are shown in Table 1. The temperature was kept at a constant 365° C. during compression. Thermoformed articles were then made from the composites and tested to determine peak heat release, total heat release, and optical smoke density as described above.

TABLE 1

| | | | Consolidated | Lofted | |
|---|---|---|---|---|---|
| | Pressure | Rate** | thickness | thickness | Degree of Loft |
| Sample ID | Bar | M/min. | Mm | Mm | minimum |
| 1 | 20 | 0.5 | 1.00 | 3.47-3.98 | 3.6 |
| 2 | 30 | 0.5 | 0.85 | 2.7-4.3 | 3.2 |
| 3 | 10 | 1.0 | 1.10 | 4.6-4.9 | 4.2 |

**Rate (meters/minute) at which the mat was introduced into the heated belts during consolidation of the mat.

As can be seen from the results in Table 1, the composites had a minimum degree of loft greater than or equal to three.

Further, thermoformed articles were made from the composites and the thermoformed articles exhibited all of the following properties: (1) a peak heat release of less than 65 kW/m², as measured by FAR 25.853 (OSU test); (2) a total heat release at 2 minutes of less than or equal to 65 kW-min./m² as measured by FAR 25.853 (OSU test); and (3) an NBS optical smoke density of less than 200 when measured at 4 minutes, based on ASTM E-662 (FAR/JAR 25.853). Formability and mechanical strength were determined as well, and found to be acceptable.

Processing conditions were adjusted to provide similar ratios across the full width of the sheet. The composite was tested for its loft properties in accordance to the procedure described above. If the minimum degree of loft was found to be 3 or more and within one sigma above 3, the composite was determined to be within the required range.

TABLE 2

| | | | Consolidated | Lofted | |
|---|---|---|---|---|---|
| | Pressure | Rate | Thickness | Thickness | Degree of Loft |
| Ex. No. | Bar | m/min. | Mm | Mm | minimum |
| 9 | 20 | 0.5 | 0.86 | 3.22-3.36 | 3.74 |
| 10 | 20 | 1 | 0.85 | 3.43-3.54 | 4.04 |
| 11 | 10 | 1 | 0.93 | 4.13-4.32 | 4.17 |
| 12 | 10 | 1 | 0.93 | 3.76-4.63 | 4.04 |
| 13 | 10 | 1 | 0.97 | 4.08-4.9 | 4.21 |

Thermoformed articles were made from the indicated composites and the thermoformed articles each exhibited all of the following properties: (1) a peak heat release of less than 65 kW/m², as measured by FAR 25.853 (OSU test); (2) a total heat release at 2 minutes of less than or equal to 65 kW-min./m² as measured by FAR 25.853 (OSU test); and (3) an NBS optical smoke density of less than 200 when measured at 4 minutes, based on ASTM E-662 (FAR/JAR 25.853). The Examples further met the mechanical requirements for strength and stiffness as determined by a third party.

### Examples 14 to 21

Additional samples were run, varying the thermoplastic fiber and binder fiber as shown on Table 3.

TABLE 3

| Example # | 14 | 15 | 16 | 17 | 18 | 19 | 20 | 21 |
|---|---|---|---|---|---|---|---|---|
| Composition | | | | | | | | |
| Fiberglass - % | OC | OC | OC | OC | OC | OC | OC | OC |
| | 40 | 40 | 40 | 40 | 40 | 40 | 40 | 40 |
| Resin - % | PPSU | PEI | 0 | PEI | PEI | PEI | Siltem | PEI |
| | 50 | 55 | 0 | 50 | 55 | 50 | 50% | 50 |
| Binder - % | FST | FST | FST | FST | PC 141 | PC 141 | FST | FST |
| | 10 | 5 | 60 | 10 | 5 | 10 | 10 | 10 |
| Toxicity - Draeger Tube | | | | | | | | |
| HCN (max. 150 ppm) | <1 | | <1 | <1 | <1 | | <1 | <1 |
| CO (max. 1000 ppm) | 112 | | 288 | 275 | 138 | | 200 | 100 |
| NO/NO₂ (max. 100 ppm) | 5 | | 3 | 10 | 5 | | 7 | 3 |
| SO₃ (max. 100 ppm) | 4 | | 5 | 3 | <1 | | 4 | <1 |
| HF (max. 100 ppm) | <1 | | <1 | <1 | <1 | | <1 | 4 |
| HCl (max. 150 ppm) | <1 | | <1 | <1 | <1 | | <1 | 1 |
| Pass/Fail | Pass | | Pass | Pass | Pass | | Pass | Pass |
| Flame Performance - | | | | | | | | |
| Vertical Burn (60 sec.) | | | | | | | | |
| Burn Time (max. 15 sec.) | 0 | 0 | 0 | 0 | 0 | 0 | 0 | 0 |
| Burn Length (max. 6 in.) | 1.4 | 1.7 | 1.6 | 1.8 | 1.8 | 1.6 | 4.4 | 1.8 |
| Longest Burn. Particle | None | None | None | None | None | None | None | None |
| (max. 3 sec.) | | | | | | | | |
| Pass/Fail | Pass | Pass | Pass | Pass | Pass | Pass | Pass | Pass |
| Flame Performance - | | | | | | | | |
| Smoke Density | | | | | | | | |
| Ds @ 1.5 m. | 2 | 3 | 11 | 0 | 4 | 10 | 32 | 0 |
| Ds @ 4 m. | 18 | 21 | 86 | 16 | 36 | 78 | 113 | 13 |
| Ds Maximum | 18 | 21 | 86 | 16 | 36 | 78 | 113 | 13 |
| D max. min. (200) | 3.57 | 3.57 | 3.58 | 3.54 | 3.58 | 3.59 | 3.69 | 3.57 |
| Pass/Fail | Pass | Pass | Pass | Pass | Pass | Pass | Pass | Pass |
| OSU Heat Release (65/65) | | | | | | | | |
| 2 min. Total (kW/m²) | 31 | 37 | 33 | 54 | 54 | 46 | 77 | 47 |
| Peak HR (kW/m²) | 30 | 32 | 30 | 39 | 44 | 36 | 54 | 37 |
| Peak Time (sec.) | 23 | 99 | 145 | 110 | 128 | 90 | 82 | 104 |
| Melting (Y/N) | No | No | No | No | No | No | No | No |
| Sagging (Y/N) | No | No | No | No | No | No | No | No |
| Dripping (Y/N) | No | No | No | No | No | No | No | No |
| 65/65 (Pass/Fail) | Pass | Pass | Pass | Pass | Pass | Pass | Fail | Pass |

All references are incorporated herein by reference.

### Embodiment 1

A composition for the manufacture of a porous, compressible article, the composition comprising a combination of: a plurality of reinforcing fibers; and a plurality of thermoplastic fibers; wherein said combination of fibers is arranged in one or more layers; and spaced continuous carrier fibers are present on, and substantially transit, a surface of at least one such layer; and said composition does not contain a scrim carrier layer.

### Embodiment 2

The composition of Embodiment 1, wherein said spaced, continuous carrier fibers transit the surface of the layer as substantially parallel fibers in the machine direction.

### Embodiment 3

The composition of Embodiment 1, wherein said spaced, continuous carrier fibers transit the surface of the layer as substantially parallel fibers in the cross-machine direction.

### Embodiment 4

The composition of Embodiment 1, wherein the continuous carrier fiber traverses the surface of the layer in a zigzag manner, in which the fiber is oriented at an angle relative to the machine direction and transit a major portion of the cross-machine width of the surface of the layer and then return on a diagonal toward the opposite edge.

### Embodiment 5

The composition of any of the previous Embodiments, comprising: from 35 to 65 wt. % of the reinforcing fibers; and from 35 to 65 wt. % of the thermoplastic fibers; each based on the combined weight of the reinforcing fibers and the thermoplastic fibers.

### Embodiment 6

The composition of any of the previous Embodiments, wherein the reinforcing fibers comprise metal fibers, metallized inorganic fibers, metallized synthetic fibers, glass fibers, graphite fibers, carbon fibers, ceramic fibers, mineral fibers, basalt fibers, polymer fibers having a Tg at least 150° C. higher than the polyimide, or a combination thereof.

### Embodiment 7

The composition of any of the previous Embodiments, wherein the reinforcing fibers comprise glass fibers.

### Embodiment 8

The composition of any of the previous Embodiments, wherein the thermoplastic fiber is selected from polyetherimide, polyetherimide sulfone, polyetherimide-siloxanes, polycarbonate, polycarbonate-siloxane, polyestercarbonate, polyestercarbonate-siloxane, polyesters, polyethylene terephthalate, polybutylene terephthalate, polyolefin, polyethylene, polypropylene, polyamides, and high performance polymers, polybenzimidazole, and liquid crystalline polymers.

### Embodiment 9

The composition of any of the previous Embodiments, wherein the thermoplastic fiber comprises a polyetherimide.

### Embodiment 10

The composition of any of the previous Embodiments, wherein the composition further comprises a polymeric binder fiber.

### Embodiment 11

The composition of Embodiment 10, wherein the polymeric binder fiber is selected from a polyamide, polysiloxane, polysiloxane-polyestercarbonate copolymer, polyester, polycarbonate, polyester-polyetherimide blend, bicomponent fiber of any of the foregoing, or a combination thereof.

### Embodiment 12

The composition of Embodiment 11, wherein the polysiloxane-polyestercarbonate copolymer comprises polysiloxane units comprising from 4 to 50 siloxane units, wherein the siloxane units are present in an amount of 0.2 to 10 wt. % of the total weight of the polysiloxane-polyestercarbonate copolymer, and polyester-polycarbonate units comprising, based on the polyester-polycarbonate units from 50 to 100 mole percent of arylate ester units, from more than 0 to less than 50 mole percent aromatic carbonate units, from more than 0 to less than 30 mole percent resorcinol carbonate units, and from more than 0 to less than 35 mole percent bisphenol carbonate units; and wherein the polysiloxane-polyestercarbonate copolymer composition has a 2 minute integrated heat release rate of less than or equal to 65 kilowatt-minutes per square meter (kW-min./m²) and a peak heat release rate of less than 65 kilowatts per square meter (kW/m²) as measured using the method of FAR F25.4, in accordance with Federal Aviation Regulation FAR 25.853 (d).

### Embodiment 13

The composition of Embodiment 11, wherein the arylate ester units are isophthalate-terephthalate-resorcinol ester units.

### Embodiment 14

The composition of any of the previous Embodiments, wherein the average fiber length of the discontinuous reinforcing fibers is from 5 to 75 millimeters and the average fiber diameter of the reinforcing fibers is from 5 to 125 micrometers; the average fiber length of the thermoplastic fibers is from 5 to 75 millimeters, and the average fiber diameter of the polyimide fibers is from 5 to 125 micrometers.

### Embodiment 15

The composition of any of the previous Embodiments, further comprising thermoplastic fibers of sub-micron diameter.

### Embodiment 16

The composition of any of the previous Embodiments, further comprising an aqueous fluid.

### Embodiment 17

A method for forming a porous article, the method comprising: forming a suspension of the composition of any of the previous Embodiments in liquid; at least partially removing the liquid from the suspension to form a web; heating the web under conditions sufficient to remove any remaining liquid from the web and to melt the thermoplastic; and cooling the heated web to form the porous mat, wherein the porous article comprises a network of the reinforcing fibers and the thermoplastic fibers.

### Embodiment 18

The method of Embodiment 17, wherein forming the web comprises: depositing the composition dispersed in an aqueous suspension onto a forming support element to form the layer; and evacuating the aqueous liquid to form the web, either by applying pressure or vacuum.

### Embodiment 19

The method of Embodiment 17, wherein the heating is at a temperature from 130 to 170° C.

### Embodiment 20

The method of Embodiment 19, wherein the heating comprises drying in an oven at a temperature from 130 to 150° C., then melting the binder via infrared heating at a temperature from 150 to 270° C.

### Embodiment 21

A porous article comprising: a network of a plurality of reinforcing fibers and a plurality of thermoplastic fibers and a plurality of spaced continuous carrier fibers which substantially transit said porous article; and said porous article does not contain a scrim carrier layer.

### Embodiment 22

The porous article of Embodiment 21, having an areal weight of from 50 to 500 g./m².

### Embodiment 23

A method of forming a composite, the method comprising: heating and compressing at least one of the porous articles of Embodiment 21 under conditions sufficient to melt the thermoplastic fibers and consolidate the network; cooling the heated, compressed article under pressure to form the composite comprising: a network comprising a plurality of reinforcing fibers; and a matrix comprising melted and cooled thermoplastic and melted and cooled polymeric binder, wherein the polymeric binder has a melt temperature lower than the thermoplastic fiber.

### Embodiment 24

The method of Embodiment 23, comprising heating and compressing a stack comprising two or more of the porous mats.

### Embodiment 25

The method of Embodiment 23, comprising heating and compressing a stack comprising two to twelve of the porous mats.

### Embodiment 26

A thermoformable composite, comprising: a network comprising a plurality of reinforcing fibers; and a matrix comprising melted and cooled thermoplastic fibers and melted and cooled polymeric binder fibers, wherein the polymeric binder has a melt temperature lower than the thermoplastic, and a plurality of spaced continuous carrier fibers which substantially transit said porous article; and said porous article does not contain a scrim carrier layer; wherein the composite has a minimum degree of loft of greater than or equal to three.

### Embodiment 27

The composite of Embodiment 26, wherein the loft of the composite is within one sigma, over the entirety of the composite.

### Embodiment 28

The composite of any of the previous Embodiments, wherein the loft of the composite is within 30%, over the entirety of the composite.

### Embodiment 29

The composite of any of the previous Embodiments, having a melting point of at least 205° C.

### Embodiment 30

The composition of any of the previous Embodiments, wherein a thermoformed article made from the composite has: a peak heat release of less than 65 kW/m², as measured by FAR 25.853 (OSU test); a total heat release at 2 minutes of less than or equal to 65 kW-min./m.² as measured by FAR 25.853 (OSU test); and an NBS optical smoke density of less than 200 when measured at 4 minutes, based on ASTM E-662 (FAR/JAR 25.853).

### Embodiment 31

The composite of any of the previous Embodiments, further having a toxic gases release of less than or equal to 100 ppm based on Draeger Tube Toxicity test (Airbus ABD0031, Boeing BSS 7239).

### Embodiment 32

The composite of any of the previous Embodiments, wherein the composite does not include a flame retardant, wherein the flame retardant is a perfluoroalkyl sulfonate salt, a fluoropolymer encapsulated vinylaromatic copolymer, potassium diphenylsulfone-3-sulfonate, sodium trichlorobenzenesulfonate, or a combination comprising at least one of the foregoing flame retardants.

### Embodiment 33

The composite of any of the previous Embodiments, further comprising a thermal stabilizer, an antioxidant, a light stabilizer, a gamma-irradiation stabilizer, a colorant, an antistatic agent, a lubricant, a mold release agent, or a combination thereof.

### Embodiment 34

A method of forming an article, the method comprising: thermoforming the composite of any of the previous Embodiments to form the article.

### Embodiment 35

The method of claim 34, wherein the thermoforming is match metal thermoforming.

### Embodiment 36

An article, comprising: a thermoformed composite of any of the previous Embodiments.

### Embodiment 37

The article of Embodiment 36, having a porosity from 30 to 200 volume % compared to the porosity of the composite.

### Embodiment 38

The article of claim 37, having a porosity from 50 to 100 volume % compared to the porosity of the composite.

### Embodiment 39

The article of Embodiment 37, wherein the article is selected from an aircraft interior panel, a train interior panel, an automobile interior panel, and a ship interior panel.

### Embodiment 40

A composite, comprising: a network comprising a plurality of reinforcing fibers selected from metal fibers, metallized inorganic fibers, metallized synthetic fibers, glass fibers, graphite fibers, carbon fibers, ceramic fibers, mineral fibers, basalt fibers, polymer fibers having a Tg at least 50° C. higher than the processing temperature of the polyimide, and combinations thereof; and a matrix comprising: (a) melted and cooled polyimide fibers and (b) melted and cooled polymeric binder fibers, wherein the polymeric binder has a melt temperature lower than the polyimide, and a plurality of spaced continuous carrier fibers which substantially transit said composite; and said porous article does not contain a scrim carrier layer; wherein the composite has a minimum degree of loft of greater than or equal to three and the loft of the composite is within 30% over the entirety of the composite.

### Embodiment 41

The article of Embodiment 40, wherein the composite does not include a flame retardant, wherein the flame retardant is a perfluoroalkyl sulfonate salt, a fluoropolymer encapsulated vinylaromatic copolymer, potassium diphenylsulfone-3-sulfonate, sodium trichlorobenzenesulfonate, or a combination comprising at least one of the foregoing flame retardants.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A composition for the manufacture of a porous, compressible article, the composition comprising a combination of:
a plurality of reinforcing fibers; and
a plurality of thermoplastic fibers;
wherein
said combination of fibers is arranged in one or more layers; and
spaced continuous carrier fibers are present on, and substantially transit, a surface of at least one such layer; and
said composition does not contain a scrim carrier layer.

2. The composition of claim 1, wherein said spaced, continuous carrier fibers transit the surface of the layer as substantially parallel fibers in the machine direction.

3. The composition of claim 1, wherein said spaced, continuous carrier fibers transit the surface of the layer as substantially parallel fibers in the cross-machine direction.

4. The composition of claim 1, wherein the continuous carrier fiber traverses the surface of the layer in a zigzag manner, in which the fiber is oriented at an angle relative to the machine direction and transit a major portion of the cross-machine width of the surface of the layer and then return on a diagonal toward the opposite edge.

5. The composition of claim 1, comprising:
from 35 to 65 wt. % of the reinforcing fibers; and
from 35 to 65 wt. % of the thermoplastic fibers;
each based on the combined weight of the reinforcing fibers and the thermoplastic fibers.

6. The composition of claim 1, wherein the reinforcing fibers comprise metal fibers, metallized inorganic fibers, metallized synthetic fibers, glass fibers, graphite fibers, carbon fibers, ceramic fibers, mineral fibers, basalt fibers, or polymer fibers having a Tg at least 150° C. higher than the polyimide, or a combination thereof.

7. The composition of claim 1, wherein the reinforcing fibers comprise glass fibers.

8. The composition of claim 1, wherein the thermoplastic fiber is selected from polyetherimide, polyetherimide sulfone, polyetherimide-siloxanes, polycarbonate, polycarbonate-siloxane, polyestercarbonate, polyestercarbonate-siloxane, polyesters, polyethylene terephthalate, polybutylene terephthalate, polyolefin, polyethylene, polypropylene, polyamides, and high performance polymers, polybenzimidazole, and liquid crystalline polymers.

9. The composition of claim 1, wherein the thermoplastic fiber comprises a polyetherimide.

10. The composition of claim 1, wherein the composition further comprises a polymeric binder fiber.

11. The composition of claim 10, wherein the binder fiber is selected from a polyamide, polysiloxane, polysiloxane-polyestercarbonate copolymer, polyester, polycarbonate, polyester-polyetherimide blend, bicomponent fiber of any of the foregoing, or a combination thereof.

12. The composition of claim 11, wherein the polysiloxane-polyestercarbonate copolymer comprises
polysiloxane units comprising from 4 to 50 siloxane units, wherein the siloxane units are present in an amount of 0.2 to 10 wt. % of the total weight of the polysiloxane-polyestercarbonate copolymer, and
polyester-polycarbonate units comprising, based on the polyester-polycarbonate units
from 50 to 100 mole percent of arylate ester units,
from more than 0 to less than 50 mole percent aromatic carbonate units,
from more than 0 to less than 30 mole percent resorcinol carbonate units, and
from more than 0 to less than 35 mole percent bisphenol carbonate units; and
wherein the polysiloxane-polyestercarbonate copolymer composition has a 2 minute integrated heat release rate of less than or equal to 65 kilowatt-minutes per square meter (kW-min/m²) and a peak heat release rate of less than 65 kilowatts per square meter (kW/m²) as measured using the method of FAR F25.4, in accordance with Federal Aviation Regulation FAR 25.853 (d).

13. The composition of claim 11, wherein the arylate ester units are isophthalate-terephthalate-resorcinol ester units.

14. The composition of claim 1, wherein
the average fiber length of the discontinuous reinforcing fibers is from 5 to 75 millimeters and the average fiber diameter of the reinforcing fibers is from 5 to 125 micrometers;
the average fiber length of the thermoplastic fibers is from 5 to 75 millimeters, and the average fiber diameter of the polyimide fibers is from 5 to 125 micrometers.

15. The composition of claim 1, further comprising thermoplastic fibers of sub-micron diameter.

16. The composition of claim 1, further comprising an aqueous fluid.

17. A method for forming a porous article, the method comprising:
forming a suspension of the combination of a plurality of reinforcing fibers; a plurality of thermoplastic fibers; and optionally a plurality of polymeric binder fibers in a liquid, for example, an aqueous solvent;
at least partially removing the liquid from the suspension to form a web;
heating the web under conditions sufficient to remove any remaining liquid from the web and to melt the thermoplastic; and
cooling the heated web to form the porous mat, wherein the porous article comprises a network of the reinforcing fibers and the thermoplastic fibers.

18. The method of claim 17, wherein forming the web comprises:
depositing the composition dispersed in an aqueous suspension onto a forming support element to form the layer; and
evacuating the aqueous solvent to form the web.

19. The method of claim 17, wherein the heating is at a temperature from 130 to 170° C.

20. The method of claim 19, wherein the heating comprises drying in an oven at a temperature from 130 to 150° C., then melting the binder via infrared heating at a temperature from 150 to 270° C.

21. A porous article comprising:
a network of a plurality of reinforcing fibers and a plurality of thermoplastic fibers and
a plurality of spaced continuous carrier fibers which substantially transit said porous article; and
said porous article does not contain a scrim carrier layer.

22. The porous article of claim 21, having an areal weight of from 50 to 500 g./m².

23. A method of forming a composite, the method comprising:
heating and compressing at least one of the porous articles of claim 21 under conditions sufficient to melt the thermoplastic fibers and consolidate the network;
cooling the heated, compressed article under pressure to form the composite comprising:
a network comprising a plurality of reinforcing fibers; and
a matrix comprising melted and cooled thermoplastic fibers and melted and cooled polymeric binder fibers, wherein the polymeric binder has a melt temperature lower than the thermoplastic fiber.

24. The method of claim 23, comprising heating and compressing a stack comprising two or more of the porous mats.

25. The method of claim 23, comprising heating and compressing a stack comprising two to twelve of the porous mats.

26. A thermoformable composite, comprising:
a network comprising a plurality of reinforcing fibers; and
a matrix comprising melted and cooled thermoplastic fibers and melted and cooled polymeric binder fibers, wherein the polymeric binder has a melt temperature lower than the thermoplastic, and
a plurality of spaced continuous carrier fibers which substantially transit said porous article; and
said porous article does not contain a scrim carrier layer;
wherein the composite has a minimum degree of loft of greater than or equal to three.

27. The composite of claim 26, wherein the loft of the composite is within one sigma, over the entirety of the composite.

28. The composite of claim 26, wherein the loft of the composite is within 30%, over the entirety of the composite.

29. The composite of claim 26, having a melting point of at least 205° C.

30. The composition of claim 26, wherein a thermoformed article made from the composite has:
a peak heat release of less than 65 kW/m², as measured by FAR 25.853 (OSU test);
a total heat release at 2 minutes of less than or equal to 65 kW-min./m.² as measured by FAR 25.853 (OSU test); and
an NBS optical smoke density of less than 200 when measured at 4 minutes, based on ASTM E-662 (FAR/JAR 25.853).

31. The composite of claim 26, further having a toxic gases release of less than or equal to 100 ppm based on Draeger Tube Toxicity test (Airbus ABD0031, Boeing BSS 7239).

32. The composite of claim 26, wherein the composite does not include a flame retardant, wherein the flame retardant is a perfluoroalkyl sulfonate salt, a fluoropolymer encapsulated vinylaromatic copolymer, potassium diphenylsulfone-3-sulfonate, sodium trichlorobenzenesulfonate, or a combination comprising at least one of the foregoing flame retardants.

33. The composite of claim 26, further comprising a thermal stabilizer, an antioxidant, a light stabilizer, a gamma-irradiation stabilizer, a colorant, an antistatic agent, a lubricant, a mold release agent, or a combination thereof.

34. A method of forming an article, the method comprising:
thermoforming the composite of claim 26 to form the article.

35. The method of claim 34, wherein the thermoforming is match metal thermoforming.

36. An article, comprising:
a thermoformed composite of claim 26.

37. The article of claim 36, having a porosity from 30 to 200 volume % compared to the porosity of the composite.

38. The article of claim 37, having a porosity from 50 to 100 volume % compared to the porosity of the composite.

39. The article of claim 36, wherein the article is selected from an aircraft interior panel, a train interior panel, an automobile interior panel, and a ship interior panel.

40. A composite, comprising:
a network comprising a plurality of reinforcing fibers selected from metal fibers, metallized inorganic fibers, metallized synthetic fibers, glass fibers, graphite fibers, carbon fibers, ceramic fibers, mineral fibers, basalt fibers, polymer fibers having a Tg at least 150° C. higher than the Tg of the polyimide, and combinations thereof; and
a matrix comprising: (a) melted and cooled polyimide fibers and (b) melted and cooled polymeric binder fibers, wherein the polymeric binder has a melt temperature lower than the polyimide, and
a plurality of spaced continuous carrier fibers which substantially transit said composite; and
said porous article does not contain a scrim carrier layer;
wherein the composite has a minimum degree of loft of greater than or equal to three and the loft of the composite is within 30% over the entirety of the composite.

41. The article of claim 40, wherein the composite does not include a flame retardant, wherein the flame retardant is a perfluoroalkyl sulfonate salt, a fluoropolymer encapsulated vinylaromatic copolymer, potassium diphenylsulfone-3-sulfonate, sodium trichlorobenzenesulfonate, or a combination comprising at least one of the foregoing flame retardants.
